(19) United States
(12) Patent Application Publication
(10) Pub. No.: US 2024/0224973 A1
(43) Pub. Date: Jul. 11, 2024

(54) SYSTEM FOR TREATING PLANTS ESPECIALLY IN AGRICULTURE

(71) Applicant: BILBERRY SAS, Gentilly (FR)

(72) Inventor: Hugo Serrat, Gentilly (FR)

(73) Assignee: BILBERRY SAS, Gentilly (FR)

(21) Appl. No.: 18/372,004

(22) Filed: Sep. 22, 2023

Related U.S. Application Data
(63) Continuation of application No. PCT/IB22/52604, filed on Mar. 22, 2022.

(30) Foreign Application Priority Data
Mar. 26, 2021 (FR) 2103071

(51) Int. Cl. A01M 7/00; A01C 23/00; A01C 23/04; A01M 21/04; B05B 1/20; B05B 12/04; B05B 12/12

(52) U.S. Cl. CPC A01M 7/0042; A01C 23/007; A01C 23/047; A01M 7/0089; A01M 21/043; B05B 1/20; B05B 12/04; B05B 12/122

(57) ABSTRACT

A plant treatment system comprises a spray boom capable of moving over an area to be treated, the boom being provided with a plurality of spray nozzles distributed over the boom and supplied by a spray control device, a set of cameras capable of taking images of an area to be treated, and a digital processing device capable of analyzing the images taken by the camera, identifying plants to be treated, and applying instructions to the spray control device in view of spraying locally, and at times determined depending on the displacement of the boom, a nominal product dose on the plants to be treated.

According to the invention, the system further comprises an error detection device capable of providing an error signal to the spray control device in case of an error, the spray control device being configured to apply by means of a plurality of nozzles, in downgraded mode, a generally uniform dose of a product to at least part of the area to be treated.

For use in cultivated or non-cultivated spaces.

### FIELD OF THE INVENTION

In general, this invention relates to the field of plant treatment.

### STATE OF THE ART

From WO2018142371A1, WO2018141995A1, and WO2018154490A1 on behalf of the applicant, methods and systems for selectively treating plants in cultivated areas or railway areas are already known. Such a system comprises a spray boom moved by a tractor and fitted with a plurality of spaced-apart spray nozzles. The boom also comprises one or more cameras capturing images of the field while the system is being moved, and one or more processing units which, by means of learning-based image recognition techniques, can recognize plants in the captured images, and control the spray nozzles in real time to locally apply treatment, e.g. a herbicide treatment, only where the presence of plants to be treated is detected.

This system allows for the use of treatment products, such as plant protection products, to be considerably reduced with respect to a conventional solution where all nozzles are fed simultaneously and continuously when the system is moving in an area to be treated.

However, one issue related to spot spraying triggered by the recognition of plants to be treated is that a number of operational conditions have to be satisfied.

In fact, such a system is likely to be confronted with a number of problems including hardware problems such as:
faulty communication between at least one camera and the digital processing unit,
a power supply error of the system, especially of the vision system consisting of the cameras and the digital processing unit,
an error of the lighting device in case of night-time working or in dark conditions,
insufficient sharpness of the images due for instance to optical malfunction of the cameras,
a position of the boom which too low or too high, or software problems such as:
an execution error of the processing programs (crash),
the presence of corrupted images, or else problems related to the working environment, such as:
the presence of dust or fog impairing the quality of the images,
the accumulation of dirt and/or humidity on the optics of the cameras, again impairing the quality of the images,
overexposure or underexposure of the images, e.g. due to sudden changes in brightness (especially clouds and sunshine),
too much wind, leading to excessive dispersion of the spray.

### SUMMARY OF THE INVENTION

The object of this invention is to limit the consequences of such problems.

For this purpose, a plant treatment system is proposed comprising a spray boom which can be displaced over an area to be treated, the boom being provided with a plurality of spray nozzles distributed over the boom and fed by a spray control device, the system comprising a set of cameras which can take images of an area to be treated, a digital processing device capable of analyzing the images taken by the camera, identifying plants to be treated, and applying instructions to the spray control device in view of spraying locally, and at times determined depending on the displacement of the boom, a nominal product dose on the plants to be treated, the system being characterized in that it comprises an error detection device capable of issuing an error signal to the spray control device in case of an error, the spray control device being configured to apply by means of a plurality of nozzles, in downgraded mode, a generally uniform dose of a product on at least part of the area to be treated.

Preferred aspects of the system include the following optional additional characteristics, taken individually or in any combination the person skilled in the art may consider as technically compatibles:
the product applied in normal mode and the product applied in downgraded mode is the same product, with the generally uniform dose being less than the nominal dose.
the system comprises two rows of nozzles distributed along the boom, one row being capable of locally spraying the plants identified, and one row being capable of carrying out the generally uniform application in downgraded mode.
the two rows of nozzles are connected to a common product container via a supplying device.
for the first row of spray nozzles, the supplying device comprises an individual control valve for each nozzle.
for the second row of nozzles, the supplying device comprises a common control valve for at least one group of nozzles.
for the second row of nozzles, the supplying device comprises a control valve for each nozzle.
the system comprises a row of nozzles distributed along the boom and which are associated with respective control valves having more than two opening states, the spray control device being capable of controlling said control valves individually in normal mode, and of selectively putting the control valves in a state allowing for the generally uniform product dose to be applied in downgraded mode.
the control valves have proportional control.
the generally uniform product dose is less than the recommended nominal dose for the product concerned.
the error detection device is configured for detecting at least one of a data transmission error, in particular of image data, a power supply error, a lighting error, a camera optics error, a software error, an image data error, and an error due to external elements such as brightness, dust, humidity, wind.

### BRIEF DESCRIPTION OF THE DRAWINGS

Further aspects, objects, and advantages of the present invention will be more apparent from reading the following detailed description of preferred embodiments thereof, provided by way of a non-limiting example and with reference to the appended drawings.

In the drawings:

FIG. 1 is a schematic partial top view of a spray boom according to a first embodiment of the present invention;

FIG. 2 is a partial side elevation view of the spray boom of FIG. 1; and

FIG. 3 is a schematic partial top view of a spray boom according to a second embodiment of the present invention.

### DETAILED DESCRIPTION

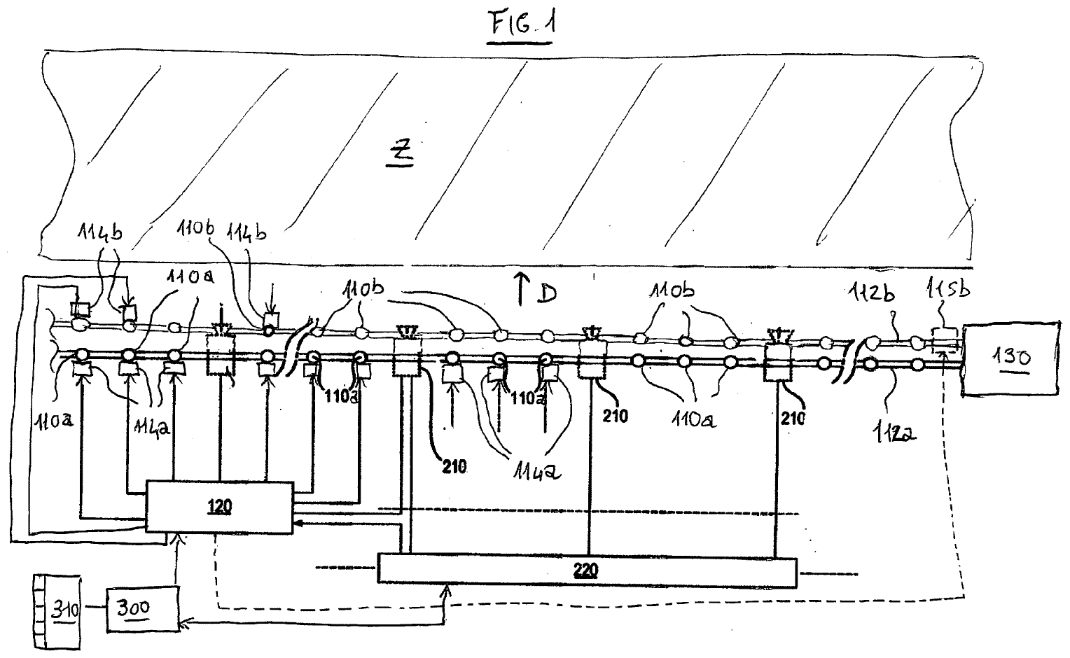

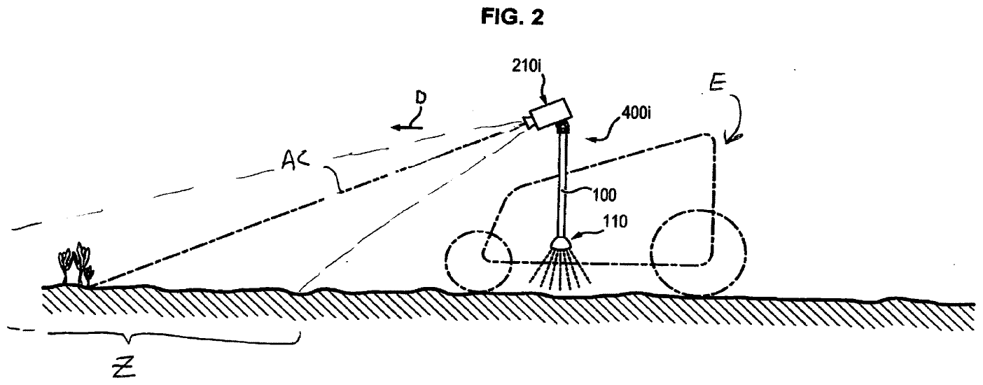

With reference to FIGS. 1 and 2, a spray boom 10 is depicted which comprises a support structure 100, which is metallic for example, and two sets of spray nozzles, both distributed along the boom 10.

A first series of spray nozzles 110a is fed by a first common line or tubing 112a connected to a source 130 of liquid to be sprayed under pressure, while a second series of spray nozzles 110b is fed by a second common line or tubing 112b also connected to the source 130 of liquid to be sprayed under pressure.

At least at the first series of nozzles 110a, spraying is controlled by a plurality of control valves 114a mounted between the common line 112a and the respective nozzle, so that each valve can be opened selectively, independently of the others, at any desired time, and thus the corresponding nozzle can be put to the line 112a for spraying the liquid.

With respect to the second series of nozzles 110b, either a plurality of control valves 114b associated with respective nozzles and capable of individually communicating the nozzles with the common line 112b, or (as illustrated in dashed lines) a single common valve 115b mounted between the container 130 of liquid to be spread and the line 112b is provided.

The different control valves are controlled by a spray control unit 120. The control valves are preferably commercially available solenoid valves with PWM control (pulse width modulation).

The boom is either incorporated into a machine E, or towed by a machine, or carried by a machine, wherein the machine may be in particular an agricultural tractor or a road or railway vehicle.

The boom 110 further carries a set of cameras 210 the axes AC of which are herein oriented in a direction from above in vertical planes parallel to the direction of travel D of the machine and capable of taking images of an area Z where the boom 100 is moving in order to identify plants to be treated. The plants can be weeds on which a herbicide is to be sprayed selectively, or can be cultivated plants on which a phytosanitary product (insecticide, fertilizer, growth regulator, etc.) is to be sprayed selectively.

The cameras 210 are connected to one or more digital processing units 220 capable of analyzing the images taken by the cameras in order to determine the presence of target plants. This analysis is done for example by decomposing each image into sub-images of a determined size, applying a convolution function to each of the sub-images by using weight matrices, and determining a probability of the presence of a target plant depending on the result of the convolution. Documents WO2018142371A1 and WO2018141995A1 on behalf of the applicant describe such techniques.

The system also comprises an error detection unit 300 cooperating with the digital processing unit 200 and with a set of sensors, together designated by reference number 310, so as to allow for a boom error signal to be sent if required by the circumstances.

This error detection unit is capable of fulfilling at least one of the following functions:
verifying communication between each camera 210 and the digital processing unit 220, e.g. by programming said unit so that it will send missing image information to the unit 300 when no image has been received,
determining a power supply error of the system, and in particular of the vision system consisting of the cameras 210 and the digital processing unit 220; in order to allow for this verification to be made, unit 300 has a separate supply from that of the monitored system, possibly with a battery back-up supply;
verifying the operation of the lighting device if such a device is fitted to the boom and supposed to be switched on, this verification can be made for example by monitoring the power supply arriving at the lamps or by means of a photodetector placed in front of one or more lamps, or else by detecting an anomaly in the brightness of the images at the digital processing unit;
estimating the sharpness of the images received by the digital processing unit 220, for example by means of a sub-program for calculating sharpness applied to the images arriving at the processing unit, and providing unit 300 with sharpness information;
detecting a program execution error of the digital processing unit (crash, freeze, etc.), for example by inserting into the programs involved normal sequence signals generated by appropriate routines;
detecting errors (especially format errors, check sum errors, etc.) in the images arriving at unit 220, again by inserting appropriate sub-programs into the unit;
by means of the set of sensors 310, detecting the presence of dust and/or fog in the atmosphere, e.g. by determining optical propagation between a light source and an associated sensor, and/or detecting the accumulation of dirt and/or humidity on the optics of the cameras (e.g. by optically determining the condition of a transparent reference plate which is exposed to the environment in the same way as the cameras, and/or detecting excessive wind by means of an anemometer provided in the set of sensors, which would largely impair spraying precision;
detecting the presence of dust or fog in the atmosphere, in this case by digitally processing captured images, for example by means of a neural network;
detecting overexposure or underexposure of the images received by the digital processing unit 220, e.g. by means of an appropriate routine inserted in the programs of said unit.

Other factors related to the operation or the environment of the boom can of course be envisaged, and in particular the behavior of a device for dynamically adjusting the inclination of the boom in case such a device is provided.

Possibly, and as suggested in some of the preceding paragraphs, each boom may comprise any complementary equipment, such as a height measuring device, a device for controlling the position or the geometry of the boom, a lighting system, etc.

Each time a plant to be treated is found in an image by the processing unit 220 the position thereof in the image allows the real position thereof in the area being treated to be inferred, and corresponding data is transmitted to the spray control unit 120.

According to one aspect of the invention, if the processing operation(s) performed by unit 300 result in the determination of normal operation, then the boom can operate normally, and control unit 120 controls spot and selective spraying of plants to be treated depending on the plant detection operation(s) performed by the vision system 210, 220, as described for example in the patent applications on behalf of the applicant, by using the first series of nozzles 110a for this purpose and carrying out individual control of the relevant control valves 112a at the times prescribed by plant detection.

In case unit 300 issues an error signal so that the boom can no longer operate normally, as explained above, a corresponding signal is applied to the control unit 120 so that it will switch spraying to downgraded mode, in which, while the machine is being displaced, uniform spraying of the area to be treated is carried out by means of all of the second series of nozzles 110b, or else spraying is carried out by means of a sub-set of the second series of nozzles 110b of a sub-area of the area to be treated, corresponding to a location where the error has been detected. Preferably, the control circuit 120 and/or the configuration of the nozzle supplying circuit are configured so that the dose applied by the nozzles 110b is substantially uniform throughout the area or the sub-area to be treated, especially considering head losses in the supply line 112b. During such spraying in downgraded mode, the first series of nozzles 110a is deactivated.

Preferably the dose applied for such spraying in downgraded mode (generally defined by product weight or volume per surface unit treated) is less than a dose applied locally during normal operation, such lower dose being obtained by appropriately controlling the control valve(s) 114b or 116b associated with the second series of nozzles. This lower dose is to minimize product application to plants, especially cultivated plants, which should normally not receive the product, and also to take into account that some plants will receive a product from two neighboring nozzles or more (due to an overlap conventionally existing in booms with multiple nozzles). This also allows for the amount of product applied to be reduced with regard to environmental and economic criteria. This may also be the application of a uniform application with a standard dose while the localized application in normal operating mode is carried out with an overdose.

Thus, in normal operation, the nozzles 110a of the first series allow for spot treatment with optimal efficiency to be carried out on the plants to be treated, detected by the vision system 210, 220, while when operating in downgraded mode, the nozzles 110b of the second series will be used to apply a safety treatment to the whole area in order to ensure thereby that all plants to be treated will be sprayed though typically at a lower dose than the nominal dose.

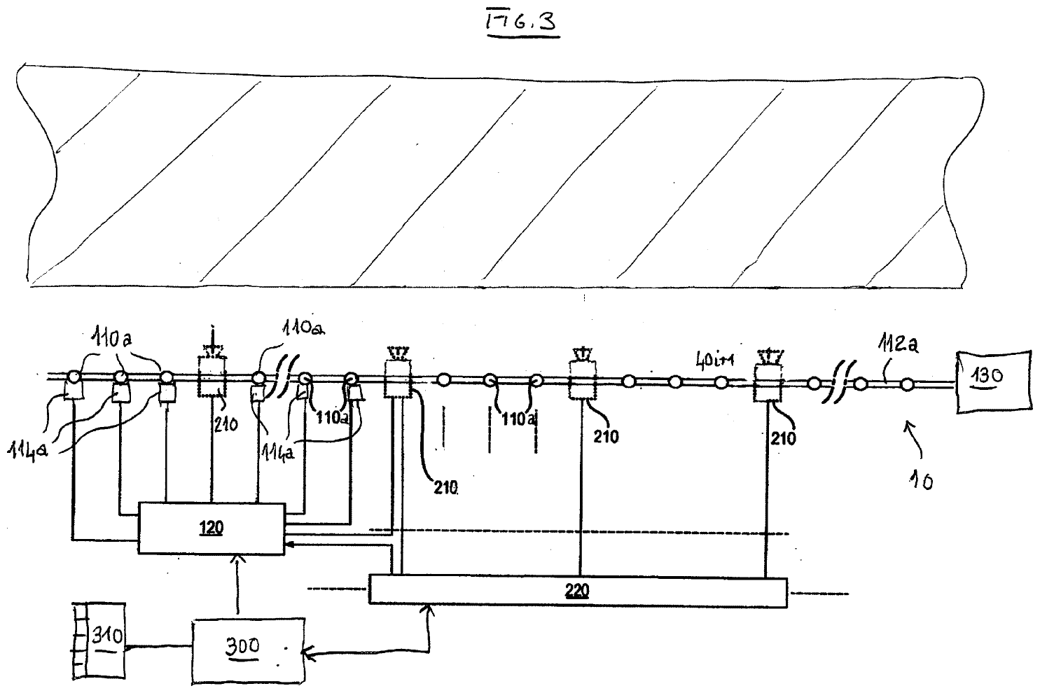

In a second embodiment and with reference to FIG. 3, the boom has a single series of nozzles 110a, each nozzle being connected to a common supply line 112a via a respective control valve.

In this embodiment, each valve 112a has proportional control in that it can release a product dose varying depending on an instruction in turn varying between 0 and 100%.

In normal operation, the valves 112a are controlled individually depending on the detection of plants by the vision system 210, 220, the nozzle involved and the starting and end times of the spot treatment being determined at the processing unit 220 and/or the control unit 120 according to system architecture. Control valve 112a of the nozzle involved is then controlled by the control unit 120 so as to perform between the calculated beginning and end times a nominal opening of the control valve 112a associated with the nozzle involved so as to perform spraying with a higher dose for the relevant product during this time window.

When unit 300 detects an error, then the set of valves 112a is controlled to be open with a degree of opening such that a generally uniform spraying of the area to be treated is carried out.

Thus, the same advantages as for the first embodiment are obtained.

Of course, the present invention is by no means limited to the embodiments described and depicted, but the person skilled in the art will be able to apply numerous variants and modifications. In particular:
a “nozzle” means both a single nozzle or a group or cluster of nozzles, e.g. nozzles operating in different directions and/or having different spraying geometries;
in the case of a group of nozzles, the associated control valves may include one valve for each nozzle, one valve for each group, or one valve for a subgroup;
the control valves, be they of the on-off type or with proportional control, can be made by any suitable technology in that they are incorporated into the nozzles or separated from the nozzles;
the system of the first embodiment can be used to apply two different products, for example a localized foliar weed killer in normal operation, and a selective herbicide in downgraded operating mode;
activation of a nozzle involved for spot spraying also includes activation of a set of neighboring nozzles;
in case of an error of the camera, the camera optics, an image, or communication between the camera and the processing unit, it can be envisaged that only the group of nozzles associated with the camera involved is put in downgraded mode;
the error detection unit 300 can apply error signals to unit 120 which differ depending on the type of error, for example in order to apply different uniform doses according to the type of error, or else if the error merely implies a coarser detection of the plants to be treated, to superimpose a localized application on a global uniform application although the local treatment will be less precise and/or the probability of the presence of a plant to be treated will be lower;
a “digital processing unit” means both a single processing device and a set of processing devices, especially for parallel processing, possibly distributed over different locations of the plant treatment system and associated with respective cameras or groups of cameras.

The present invention relates to agriculture as well as to any field where plant treatment may be required, for example application of a herbicide to weeds, in particular the treatment of areas in the field of transport, urban management, etc.

1. A plant treatment system, comprising a spray boom capable of moving over an area to be treated, the boom being provided with a plurality of spray nozzles distributed over the boom and supplied by a spray control device, the system comprising a set of cameras capable of taking images of an area to be treated, a digital processing device capable of analyzing the images taken by the camera, identifying plants to be treated, and applying instructions to the spray control device in view of spraying locally, and at times determined depending on the displacement of the boom, a nominal product dose on the plants to be treated, the system being characterized in that it comprises an error detection device capable of issuing an error signal to the spray control device in case of an error, the spray control device being configured to apply by means of a plurality of nozzles, in downgraded mode, a generally uniform dose of a product to at least part of the area to be treated.

2. The system according to claim 1, characterized in that the product applied in normal mode and the product applied in downgraded mode is the same product, with the generally uniform dose being less than the nominal dose.

3. The system according to claim 1 or 2, characterized in that it comprises two rows of nozzles distributed along the boom, one row being capable of locally spraying the plants identified, and one row being capable of performing the generally uniform application in downgraded mode.

4. The system according to claims 2 and 3 combined, characterized in that both rows of nozzles are connected to a common product container via a supplying device.

5. The system according to claim 3 or 4, characterized in that the supplying system comprises for the first row of spray nozzles an individual control valve for each nozzle.

6. The system according to claim 5, characterized in that the supplying system comprises for the second row of nozzles a common control valve for at least one group of nozzles.

7. The system according to claim 5, characterized in that the supplying system comprises for the second row of spray nozzles a control valve for each nozzle.

8. The system according to claim 1 or 2, characterized in that it comprises a row of nozzles distributed along the boom and which are associated with respective control valves having more than two opening states, the spray control device being capable of controlling said control valves individually in normal mode, and of selectively switching the control valves simultaneously into a state allowing for the generally uniform product dose to be applied in downgraded mode.

9. The system according to claim 8, characterized in that the control valves have proportional control.

10. The system according to any of claims 1 to 9, characterized in that the error detection device is configured for detecting at least one of a data transmission error, in particular of image data, a power supply error, a lighting error, a camera optics error, a software error, an image data error, and an error due to external elements such as brightness, dust, humidity, wind.
